(19) United States
(12) Patent Application Publication
(10) Pub. No.: US 2012/0129117 A1
(43) Pub. Date: May 24, 2012

(54) ORTHODONTIC TEETH POSITIONING APPLIANCES

(75) Inventor: Andrew McCance, West Susex (GB)

(73) Assignee: ORTHO-PRO-TEKNICA LIMITED, West Sussex, GB (UK)

(21) Appl. No.: 13/130,563

(22) PCT Filed: Nov. 20, 2009
(86) PCT No.: PCT/GB09/02725

§ 371 Date: Jun. 20, 2011

(30) Foreign Application Priority Data
Nov. 21, 2008 (GB) 0821366.2

(51) Int. Cl. A61C 7/10; A61C 7/00

(52) U.S. Cl. 433/7; 433/2

(57) ABSTRACT

An Orthodontic teeth positioning appliance comprising an anterior positioning component, a posterior component and a resilient means connecting the anterior and posterior components. The anterior positioning component is configured to be in contact with, in order to push against, the lingual faces of a plurality of anterior teeth, when worn by the user and the posterior component is configured to be anchored to at least one posterior tooth, when worn by the user in order that the resilient means urges apart the anterior positioning component from the posterior component. The appliance is preferably removable by the user.

### FIELD OF THE INVENTION

The present invention relates generally to the field of orthodontics and especially to orthodontic appliances that can be used in the treatment of malocclusions (i.e. misalignments of the teeth). More specifically, the invention relates to orthodontic appliances that can be used to spread, and realign crowded teeth.

### BACKGROUND

Malocclusion is the misalignment of teeth and/or an incorrect relation between the teeth of the two dental arches, giving rise to faulty contact between upper and lower teeth; i.e. a lack of normal occlusion. Correcting malocclusions is desirable for functional as well as aesthetic reasons. Uneven distribution of masticatory forces, for example, can result in excessive wear and loosening of teeth and crowding of teeth can mean cleaning is more difficult leading to increased plaque and greater susceptibility to caries.

In some cases, for example when seeking to correct malocclusion in a crowded arch (i.e. where there is inadequate space for the teeth), the treatment includes the separation of teeth within the arch to provide satisfactory space. Drawing the teeth outwards to alleviate the crowding of the teeth in the arch is one step towards creating a normal or near-normal occlusion. Afterwards it is often desirable to re-close spaces between teeth, by moving teeth back towards “normal” positions, in order to move further towards normal occlusion.

Conventionally, malocclusions are corrected through the use of orthodontic appliances, commonly known as “braces”, which may be either “fixed” or removable”. Fixed appliances include a series of metal or ceramic attachments that are cemented to the teeth and connected by tensioned wires that apply forces to the attachments, and hence to the teeth, to give the desired movement. There is wide variation in the physical properties of different tensioning wires, enabling many different movements of teeth to be undertaken as desired. For example, stainless steel wires are strong and resilient and can, in sufficient thickness, provide a rigid base upon which the teeth can be moved into ideal final positions, whereas more flexible wires (for example, from Nickel Titanium) known as “memory wires” can be easily deformed and exhibit significant ‘spring back’ to their original shape when bent. These memory wires are particularly useful in the initial phases of levelling and aligning teeth.

Conversely, removable appliances are able to be removed easily, often by the user, and are not cemented into the mouth. These generally have a rigid base plate, formed from plastic, acrylic or rubber, into which other components can be incorporated to increase the retention of the plate or to facilitate tooth movement.

At present removable appliances are generally fabricated from one major polymer material, for example methyl methacrylate or polymethyl methacrylate. This polymer material is generally held in place by means of additional wire components. Components are also added in the form of screws springs or flexible wires of many varying shapes and designs to act against teeth to obtain the desired movement.

Another type of removable appliance is the “functional appliance”. These are widely used in the treatment of children, whilst the user's jaw is still growing. The appliance is again made from one main polymer material as detailed above with additional wire components to aid in retention, and also, in some instances, to facilitate individual tooth movements. The appliance is manufactured in a postured jaw position and thus can encourage mandibular or maxillary growth to effect a sagittal correction of the underlying jaws and teeth.

These conventional appliances are, however, not without problems. The procedures for attaching the appliances to the teeth are not straightforward and require a high level of operator skill. These appliances are generally unsightly and cause problems themselves in maintaining dental hygiene, with the attachments acting as traps for food as it is chewed. The brackets and wires can be sharp and cause ulceration and discomfort by rubbing against the patient's cheek, tongue and lips.

Tooth positioners are an alternative to conventional metal braces that have gained in popularity in recent years

The concept was first proposed in the 1940s by Dr. Harold Kesling as an appliance for the final positioning of teeth following use of more conventional orthodontic appliances (see: Kesling, “The Philosophy of the Tooth Positioning Appliance”, Am. J. Orthod. Oral. Surg. (1945) 31(6):297-304). Kesling proposed a positioner made of a resilient deformable rubber that had opposed ‘U’-shape channels moulded to fit over the occlusal and incisal surfaces of the upper and lower arches respectively, applying forces to the teeth to influence their position as well as to maintain a desired relationship between the upper and lower arches. Kesling's positioners are also described in his U.S. Pat. No. 2,531,222 and another early example of a tooth positioner is seen in GB 1550777 (Suyehiro).

It is only much more recently, however, that positioners have been proposed as a realistic alternative to conventional metal braces. Recent examples of tooth positioners include those provided by Ortho-Pro-Teknica Ltd under the brand name ClearStep™ and by Align Technology, Inc. under the brand name Invisalign™.

These positioners can comprise moulded polymeric trays or shells of generally U-shape form that fit over the teeth of the upper or lower arch. They are colourless and transparent so are aesthetically much improved compared with the conventional braces. A realignment of the teeth can be achieved by using a series of positioners, each positioner typically to be worn for a period of several weeks, to incrementally reposition the teeth. The positioners can be removed by the patient themselves to allow their teeth to be cleaned avoiding the dental hygiene problems associated with the fixings of metal braces.

More severe malocclusions, however, generally cannot be corrected by re-positioning of teeth alone using these known positioners. For instance, in the case of a treatment involving severe crowding, it has been necessary to first use conventional fixed orthodontic appliance to separate/spread the teeth (and complete other coarse corrections), with the positioners subsequently being used for a final alignment of the teeth. Such comprehensive treatments have inevitably involved the use of fixed appliances with their attendant disadvantages noted above.

### SUMMARY OF THE INVENTION

A general aim of aspects of the present invention is to provide removable teeth positioning appliances that are effective and easy to use, hidden from view, and move crowded teeth downwards or upwards, moving the teeth into a broader and longer dental arch form, and separating any overlapping teeth, in advance of further repositioning.

“Removable appliances” are appliances that can be removed from and replaced on a patient's dental arch relatively easily, typically by the patient themselves. This facilitates cleaning of both the device itself and the dentition. It also means that the appliance can be manufactured in the lab (or other manufacturing facility) rather than directly in the patient's mouth

In contrast, “fixed appliances” are cemented to the dentition to fix them in place and must therefore be constructed in situ in the patient's mouth. They tend to be adjusted and eventually removed (once treatment, or the relevant phase of a treatment, is complete) by an orthodontist.

In a first aspect, the invention provides an orthodontic teeth positioning appliance comprising:
an anterior positioning component,
a posterior component,
a resilient means connecting the anterior and posterior components,
   wherein;
the anterior positioning component is configured to be in contact with, in order to push against, the lingual faces of a plurality of anterior teeth, when worn by the user,
the posterior component is configured to be anchored to at least one posterior tooth, when worn by the user, and,
the resilient means urges apart the anterior positioning component from the posterior component.

In most cases there will be two posterior components, one for each side of the arch, each one secured to a respective tooth distal to the anterior teeth of the arch to which the anterior component is secured. Typically the, or each, posterior component will be secured to only a single tooth, normally a posterior tooth (i.e. a bicuspid or a molar tooth), known as the ‘anchoring tooth’. The posterior component is preferably a unit of resilient polymeric material, but can be made from any of a range of materials including rubber, polycarbonate, and acrylic.

Conveniently, when two posterior components are used, a second resilient means can be used to urge the posterior components apart from one another (laterally across the patient's arch). This second resilient means may take the form of an omega loop spring, a conventional coil spring, a memory (e.g. Nickel Titanium—‘NiTi’) wire, or any other urging means.

The (or each) posterior component may comprise a clasp, for instance a clasp that extends part way around one of both sides of crown of the tooth to which it is secured (e.g. a ‘J’ shape or ‘C’ shape clasp), in order to anchor the posterior component.

The posterior element(s) may also comprise a polymeric “bite block”, to prevent upper and lower teeth coming into contact, and serving to open the user's bite. This block is made of a strong and resilient material, sufficient to resist the considerable bite forces of the user.

The appliance may be for the maxillary (top) or the mandibular (bottom) arch. For some treatments, a patient may wear a teeth positioning appliance in accordance with this aspect of the invention on each of the maxillary and mandibular arches.

Typically the anterior component will be formed from a block of resilient polymeric material, but can be made from any of a range of different materials including rubber, polycarbonate, and acrylic, and is secured to at least one anterior tooth. Preferably, the anterior component extends across all of the anterior teeth and is individually attached to each tooth.

Optionally, the resilient means may be attached to the posterior component using detachable means such as magnets, clip hooks, or any other detachable method. In this way, the anterior component can be removed, separately from the posterior component, to facilitate cleaning, or to replace with another anterior component and resilient means combination. In this way, the patient can have a range of urging forces applied, over a long period of time, using a variety of anterior components and resilient means, whilst using a single posterior component that can remain in place.

The anterior component may be formed from a material of constant resilience (eg. A Methacrylate polymer, rubber, polycarbonate, or acrylic), so that all of the anterior teeth, that the anterior component pushes against, are acted upon by a substantially constant force. In some embodiments, however, the sections of the anterior component which directly contact with the lingual side of each tooth may be formed of materials of differing stiffnesses and/or constructions. This allows each tooth to be acted upon by an individual force, proportional to the stiffness of the material urging it, and allows for greater control of distances moved.

Conveniently, in the case where one or more teeth do not need to be moved, the anterior component can bypass attachment to said teeth, and the area of anterior component attached to the lingual side of each tooth can be made of a significantly less dense material, providing little or no movement.

The present invention may also comprise a buccal component, comprising, for example, a fixed drape, which stops the teeth being moved more than is desired by the anterior component. Preferably the lingual face of the buccal component will include indents, into which the teeth can fit, which guide the teeth into predetermined positions, which may be deemed to comprise a “normal occlusion”. Preferably, the buccal component is transparent, which may improve its aesthetic appearance.

Optionally, the buccal component can be substituted for a removable moulded polymeric tray or shell of generally U-shape cross-sectional form that fits over the teeth of the arch in question, which can guide the teeth into precise desired positions.

The resilient member is preferably an urging member. It may be a spring, such as a coil spring. A nickel-titanium (Ni—Ti) coil spring is preferred. Alternatively the urging member may be an omega loop, or any other resilient means of applying the desired force.

The resilient member can be connected to the anterior component at one end and to the posterior component at the other end and sized so that when the appliance is secured in position in the mouth the resilient member is placed under compression (i.e. squeezed between the two components), to apply the desired force urging (i.e. in this case pushing) the anterior and posterior components away from one another.

Conveniently, the resilient member can be a coil spring mounted on a wire (i.e. with the wire passing through the spring's coils). The wire can follow the path of the dental arch, and is embedded in the anterior and posterior components, with a sliding connection, such that the separation of the anterior and posterior components follows a predetermined path.

When the coil spring is mounted on the wire, it may be fixed at either end, via respective connection portions (e.g. hooks, eyes, magnets or other methods of connection), to the anterior component and the posterior component. Preferably, the connection portions of the spring are fixed to the anterior and posterior components at points offset from the points at which the wire connects to the anterior and posterior components. Accordingly, possible interference with the sliding of the posterior component over the wire, by the connection portions, can be avoided.

In a second aspect, the invention provides an orthodontic teeth positioning appliance comprising:
a positioning component for mounting against the lingual face of one or more teeth in a dental arch;
wherein,
the positioning component comprises a plurality of regions that
each bear against the lingual tooth surface of one or more teeth, when worn by the user, and each region having differing material properties from that of at least one of the other regions.

The positioning component of the appliance may be permanently fixed (e.g. bonded, cemented, etc) to the dentition. More preferably, however, the appliance is removable.

The appliance may comprise anterior and posterior positioning components as described above in the context of the first aspect.

Each region of the appliance, as defined above, may be specifically designed to have a specific strength or flexibility such that the appliance can deliver different levels of force on individual teeth. Thus, rather than a single polymeric material being used to construct the whole appliance and then wire or other active materials being added to the polymer, the above appliance may have polymers of different physical properties bonded together into a composite appliance, with regions as described above.

Generally, the appliance is composed of a stiff central core, which is rigid and inflexible, whereby affording the appliance a great degree of strength and stability. Working outwards from the core, material of gradually increasing flexibility may be bonded such that at the tooth level, a very flexible and easily deformable material is in contact with the tooth. This can thus impart relatively gentle repositioning forces to the teeth themselves. Conversely, in areas where a greater force is required to move the teeth in question a greater distance, a harder, more impact resistant, material may be bonded to the core material, giving a greater resilience.

Very soft materials, generally used to permit gentle tooth movements, are very poor at retaining the wire components, such as archwires, which can tear the material. Accordingly, in such areas, the wires are encased in a harder impact resistant material providing a greater surface area upon which the more flexible material can be bonded.

Other optional features of this second aspect include those discussed above in the context of the first aspect.

In a third aspect, the invention provides an orthodontic teeth positioning appliance comprising:
a positioning component bearing against the lingual face of at least one anterior tooth in a user's dental arch when worn and,
a separate, removable buccal component in contact with the buccal face of the at least one anterior tooth in a user's dental arch when worn;
   wherein,
the anterior positioning component urges teeth outwards from the centre of the mouth when worn by the user and,
the buccal component retains teeth in such a way that they are not forced outwards by the anterior positioning component more than desired.

The appliance of this third aspect may comprise the anterior and posterior positioning components of the first aspect above. The appliance may also comprise the variable stiffness regions of the second aspect above.

Other optional features of this third aspect include those discussed above in the context of the first and second aspects.

Typically, the buccal component is attached to the same rear anchoring teeth as the posterior components. Preferably, the buccal component is anchored using resilient elastic members formed of conjoined loops of elastic material in a linear form known as ‘power chains’. As these power chains are formed of several consecutive loops, any of these loops can be attached to the anchoring teeth, and thus the power chain can be adjusted to a predetermined, desired, tightness so as to aid the control of how far the teeth move when urged by the anterior component.

Optionally, the buccal component may too have elastic properties, such that it can be applied to the buccal surface of the teeth in tension, such that, over time, it will urge the teeth in a lingual direction without the need for ‘power chains’.

Conveniently, the buccal component is, or power chains are, attached to the same clasps that attach the posterior component(s), by attachment to “J” or “C” hooks. Optionally, however, the buccal component may be attached using other removable means such as magnets, Velcro, or other materials having adhesion properties. This simplifies fitting of the buccal component, allows for ease of removal, and limits the required number of attachment points in a user's mouth.

### BRIEF DESCRIPTION OF DRAWINGS

Embodiments of the invention will now be described, by way of example only, with reference to the accompanying drawings, in which:

FIG. 1 is a plan view of a teeth positioning appliance according to an embodiment, incorporating the first and second aspects of the invention.

FIG. 2 is a plan view of a teeth positioning appliance according to another embodiment, incorporating the first and second aspects of the invention.

FIG. 3 is a plan view, on an enlarged scale, of the resilient means used in the appliance of FIG. 1.

FIG. 4 is a plan view, on an enlarged scale, of the resilient means used in the appliance of FIG. 2.

FIG. 5 is a plan view of the teeth positioning appliance according to an embodiment, incorporating the first, second, and third aspects of the invention.

FIG. 6 is a side elevation view of the appliance of FIG. 5.

FIG. 7 is a plan view of a teeth positioning appliance in accordance with another embodiment incorporating the first and third aspects.

FIG. 8 is a further plan view, on an enlarged scale, of one side portion of the appliance of FIG. 7.

FIG. 9 is a plan view of a teeth positioning appliance according to an embodiment of the second aspect of the invention.

FIG. 10 is plan view of a teeth positioning appliance according to an embodiment of the first and third aspects of the invention.

### DETAILED DESCRIPTION

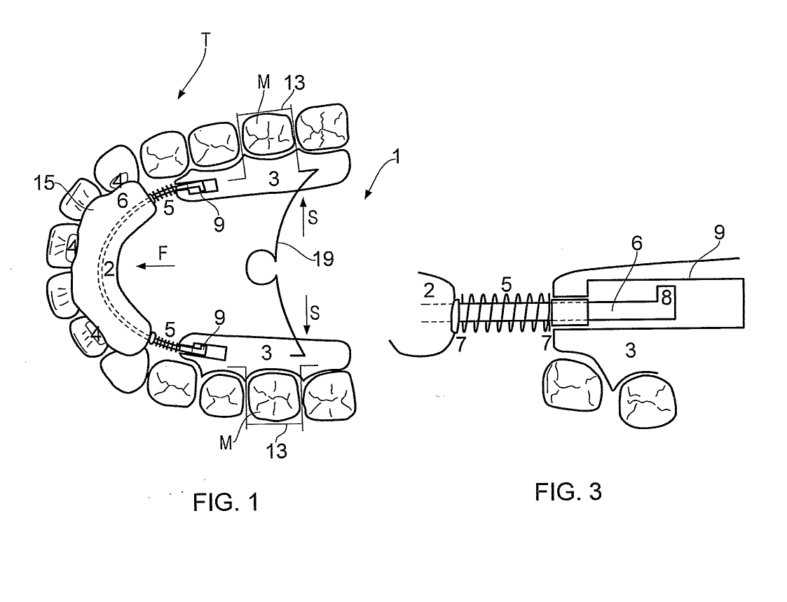

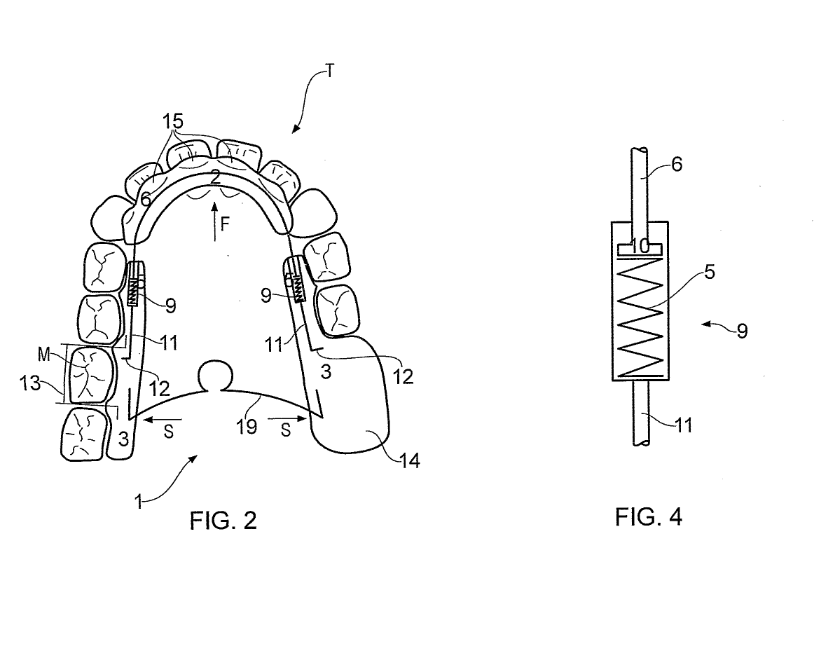

The removable tooth positioning appliance [1] of FIG. 1, as well as that of FIGS. 2, 5 and 7, includes a single anterior component [2] and a pair of posterior components [3]. When worn by a patient, the anterior component [2] is urged apart from the posterior components [3] by a part of resilient means [5] held between respective ends of the anterior component [2] and the adjacent posterior component [3], in order to separate or spread the teeth [T].

The anterior component [2] is formed from a resilient block of acrylic methyl methacrylate, upon which a layer of softer ethylethacrylate polymer is bonded, which lies in contact with, and provides gentle urging forces to, the lingual faces of a plurality of the user's teeth. These two component materials are bonded together by a chemical reaction and by curing with heat and pressure.

The exact shape of the anterior component can be formed based on an impression of the patient's arch or, more preferably, a modified or ‘ideal’ model of the patient's arch. In the latter case the anterior component [2] is itself an ‘active’ component and serves to reposition the teeth itself, aided in the anteroposterior alignment by addition of the spring loaded mechanics of the resilient means [5]. The posterior component may also be an ‘active’ component in a similar way.

In all of the below examples, the appliance is configured such that the resilient means [5] is under compression when the appliance is fitted to the user's dental arch [T], and thus exerts a force [F] on the anterior teeth, resulting in a spreading effect.

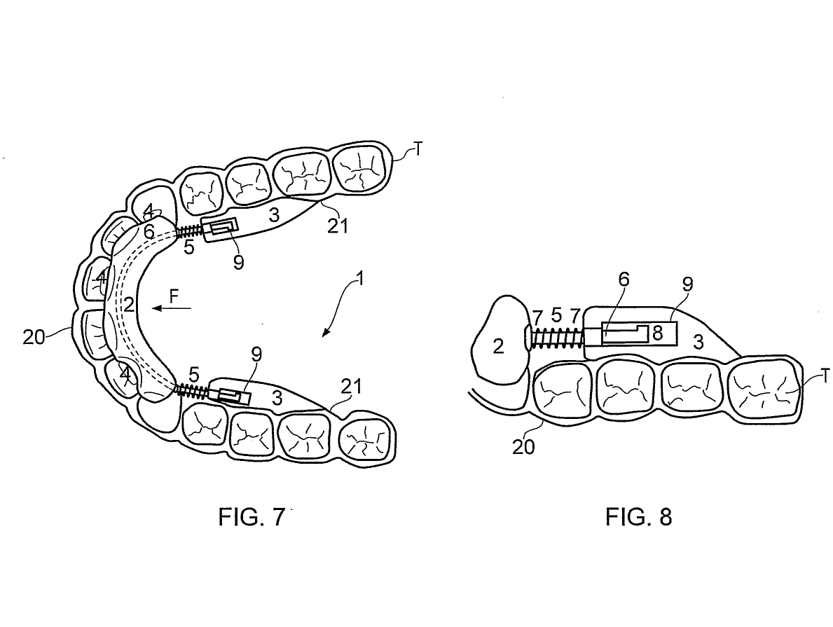

In FIG. 1, the anterior teeth are fitted with fixed (e.g. cemented) attachments [4], with which the anterior component [2] engages, as also seen in FIG. 7. The anterior component itself can, however, be disengaged form the attachments to enable the patient to remove the appliance themselves.

The engagement between the anterior component and the cemented attachments can be configured to help control the direction in which force is applied to the anterior teeth. For example, where the anterior component engages the underside of the attachment it can apply a force to extrude the tooth. This can also be seen in the example of FIG. 7.

Optionally, similar attachments can also be cemented onto the posterior teeth to aid in retention and as an aid to uprighting or anti tipping of the teeth on translation of the tooth. The attachment itself is passive but the soft base plate material, for example ethylethacrylate, can be distorted such that it is compressed under the attachment, thus bearing upwards on it, and move the tooth as desired.

The posterior component [3] lies in contact with the lingual face of a plurality of posterior teeth, for example premolars and molars. The posterior component is also anchored to at least one posterior tooth, for example a molar [M]. The anchor may be an Adam's Crib [13], which is securely engaged around the molar [M], with its ends embedded into the posterior component [3]. This can also be seen in the examples of FIGS. 2, 5, 9 and 10.

Also in FIG. 1, the resilient means [5] is shown as a coil spring mounted substantially concentrically about an archwire [6]. The archwire [6], which may be stainless steel and is preferably of rectangular (or other noncircular) cross-section, although very large diameter round wires may be also used, is embedded into the anterior component [2]. It may be held in place, for example, by a layer of an acrylic resin material bonded over the archwire [6] onto the material of the anterior component [2] or it may be moulded into the anterior component itself. This can also be seen in the examples of FIGS. 3, 7, and 8.

In accordance with the second aspect of the invention, the face of the anterior component [2] which is in contact with the lingual side of the anterior teeth comprises regions of differing stiffness [15], such that while a constant force [F] is applied to the anterior component [2] by the resilient means, each tooth, or group of teeth, can have a different force applied to them, proportional to the stiffness of the region of anterior component [2] bearing against them. This can also be seen in FIGS. 2, 5 and 9.

In this example a second resilient means [19] extends between the two posterior components [3]. This second resilient means, which may be an omega spring, urges the two posterior components outwards in the direction of force ‘S’. In this way the posterior components serve to urge the posterior teeth they contact outwardly to further open the arch. This can also be seen in the examples of FIGS. 2, 5, 9, and 10.

In FIG. 2, opposite ends of the archwire [6] are terminated within expansion chambers [9] inside respective posterior components [3]. The ends of the archwire are ‘L’ shaped to restrict the archwire [6] from leaving the chamber [9]. The archwire is thus slidably connected to the posterior component [3] such that as the anterior component is urged away in the direction of force [F], the resilient means [5] expands, and the archwire [6], slide within the chamber [9], whilst keeping the posterior [3] and anterior [2] components aligned. This can also be seen in the examples of FIGS. 3, 7 and 8.

The anchor can alternatively be, or comprise, a “bite block” [14], as also seen in FIG. 2, which will serve to additionally open the user's bite, and should be constructed from an impact resistant, relatively resilient, material to resist bite forces.

Optionally, where anchor wires [13] are used, these may also be embedded in a strong, generally non-flexible material, in order to resist rotation and tearing of the posterior component. This negates the possibility of the wires spinning or rotating in the base material and then ulcerating through and damaging the soft tissue cheek, lip, tongue, gingivae or mucosa of the patient's mouth.

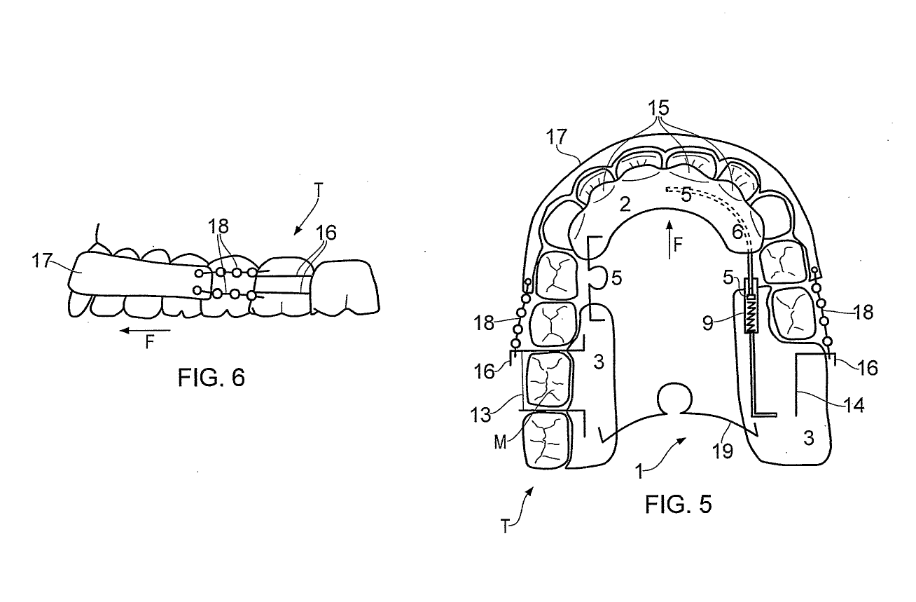

The resilient means [5] can also be seen in FIG. 2 as an internal coil spring. The coil spring [5] is retained inside an expansion chamber [9] inside the posterior component. The spring acts on a plunger [10] at the end of the archwire [6]. The other end of the spring being formed with an anchor wire [11], which terminates in an ‘L’ shape [12], embedded in the posterior component [3]. This can also be seen in the example of FIG. 5, and as an enlarged version in FIG. 4.

FIG. 3 illustrates the spring's two connection portions [7], one connection portion [7] being provided at either of its ends, and attached to, or butted against, the posterior [3] and anterior [2] components respectively.

FIG. 4 illustrates, on an enlarged scale, the internal coil spring [5] as described above.

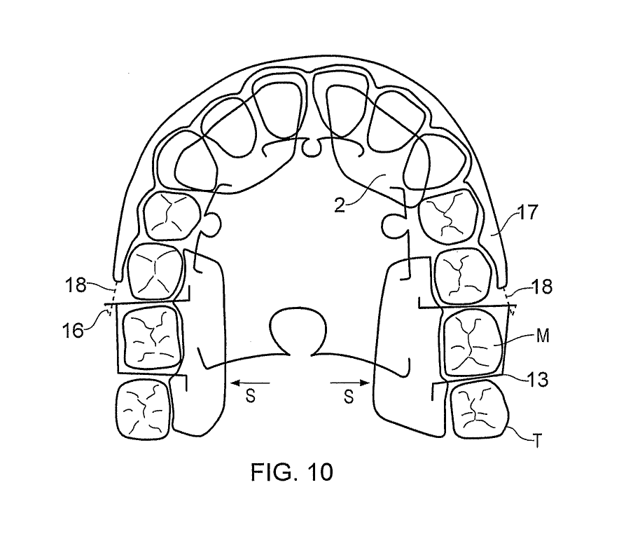

In the example of FIG. 5, one resilient means [5] is as shown as an omega loop spring. The omega loop spring forms part of the archwire [6] and thus guides the anterior [2] and posterior [3] components, as well as providing the urging force, as they move relative to one another. This can also be seen in the example of FIG. 10.

As also seen in FIG. 5, the posterior component [3] or Adams cribs [13] can be fitted with an external anchoring hook [16], which extends outwards beyond the buccal side of the teeth [T]. These anchoring hooks [16] can be used to retain a buccal component [17], which serves to guide and ultimately restrain the outward movement of the anterior teeth, in accordance with the third aspect of the invention ensuring that they are not urged further in the direction of force [F] than desirable. This can also be seen in the example of FIG. 6. This buccal component [17] can, optionally, be restrained to the anchoring hooks by means of power chains [18], or adhesion pads, advantageously meaning that the extent to which the buccal component [17] is restrained can be varied, also seen in FIGS. 5 and 6.

FIG. 6 is a side elevation of an embodiment of the third aspect, and includes the anchoring hooks [16], power chains [18], buccal component [17] and Adam's cribs [13] described above.

FIG. 7 shows yet another aspect of the invention, wherein the teeth positioning appliance can, optionally, be used in conjunction with a removable moulded polymeric tray or shell of generally U-shape cross-sectional form that fits over the teeth of the arch in question tooth positioner [20]. This can also be seen in the example of FIG. 8.

The posterior components [3] are fixedly mounted to the lingual face of the polymeric tray [21] as seen in FIG. 7. The anterior component [2] then exerts force [F] on the anterior teeth, as described, which urge the teeth against the polymeric tray [20], which in turn guides the teeth into predetermined positions. The lingual side of an anterior portion of the tray [21] is cut away in order that the anterior component [2] can contact the anterior teeth directly.

FIG. 8 shows the coils spring [5], along with some of the other aspects shown in FIG. 7 on an enlarged scale.

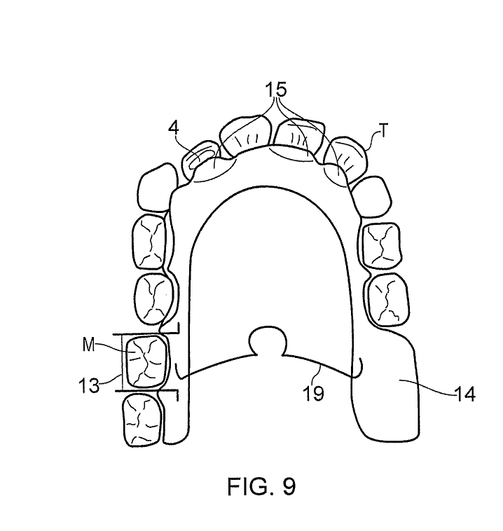

FIG. 9 shows a further embodiment of the invention, according to the second aspect of the invention, where the anterior and posterior components are substituted by a single, sufficiently resilient component which extends throughout the anterior and posterior teeth.

Regions [15] of an anterior portion of the positioning component have different stiffnesses from one another to apply different pressure to the teeth they contact in the manner already discussed above.

1. An Orthodontic teeth positioning appliance comprising:
an anterior positioning component;
a posterior component; and
a resilient means connecting the anterior and posterior components,
wherein the anterior positioning component is configured to be in contact with, in order to push against, lingual faces of a plurality of anterior teeth, when worn by the user,
wherein the posterior component is configured to be anchored to at least one posterior tooth, when worn by the user, and
wherein the resilient means urges apart the anterior positioning component from the posterior component, and wherein the anterior positioning component comprises a plurality of regions of differing stiffness and/or construction.

2. The appliance of claim 1, wherein the posterior component is configured to contact a lingual face of at least one posterior tooth.

3. The appliance of claim 1, wherein the appliance is configured to be removable.

4. The appliance of claim 1, wherein the anterior positioning component is comprised of two or more sections connected to one another.

5. (canceled)

6. The appliance of claim 1, wherein the anterior positioning component is configured to extend at least across incisor teeth when worn.

7. (canceled)

8. The appliance of claim 1, wherein the posterior positioning component is configured to extend across at least molar teeth when worn.

9. The appliance of claim 1, wherein the posterior positioning component is attached to every tooth within its range.

10. (canceled)

11. (canceled)

12. The appliance of claim 1, further comprising a guide component, extending across a buccal surface of a plurality of the user's teeth, to guide at least one tooth towards a predetermined position, as the guide component is moved by the anterior component.

13. (canceled)

14. The appliance of claim 1, wherein each region of differing stiffness bears against at least one individual tooth such that a differing force can be applied to each tooth as desired.

15. An orthodontic teeth positioning appliance comprising:
a positioning component for mounting against a lingual face of one or more teeth in a dental arch;
wherein the positioning component comprises a plurality of regions that each bear against a lingual tooth surface of one or more teeth, when worn by a user, and each region having differing material properties from that of at least one of the other regions.

16. The appliance of claim 15, wherein each region of an individual stiffness bears against at least one tooth such that an independent force can be applied to each tooth as desired.

17. (canceled)

18. (canceled)

19. The appliance of claim 15, wherein a region of an anterior positioning component on a lingual side of each tooth is a different density.

20. The appliance of claim 15, wherein regions of an anterior positioning component on a lingual side of each tooth are constructed of differing materials.

21. An orthodontic teeth positioning appliance comprising:
a positioning component bearing against a lingual face of at least one anterior tooth in a user's dental arch when worn; and
a separate, removable buccal component in contact with a buccal face of the at least one anterior tooth in a user's dental arch when worn;
wherein the anterior positioning component urges teeth outwards from a centre of a mouth when worn by the user, and
wherein the buccal component retains teeth in such a way that the teeth are not forced outwards by the anterior positioning component more than desired.

22. (canceled)

23. (canceled)

24. (canceled)

25. (canceled)

26. The appliance of claim 21, wherein the buccal component has grooves such that the teeth are guided into pre-determined positions.

27. The appliance of claim 21, wherein the buccal component is anchored to a molar tooth.

28. The appliance of claim 21, wherein the buccal component is anchored to a molar tooth by a power chain.

29. The appliance of claim 28, wherein the power chain is adjustable, to control an amount of movement in the anterior teeth as desired.

30. (canceled)

31. (canceled)

32. (canceled)

33. The appliance of claim 21, wherein the buccal component is transparent.

34. The appliance of claim 21, wherein the buccal component is flexible.

35. The appliance of claim 1, wherein the region of the anterior positioning component on a lingual side of each tooth is a different density.

36. The appliance of claim 1, wherein the regions of the anterior positioning component on a lingual side of each tooth are constructed of differing materials.
